(19) United States
(12) Patent Application Publication
(10) Pub. No.: US 2013/0065582 A1
(43) Pub. Date: Mar. 14, 2013

(54) SEAMLESS SMS BACK

(71) Applicant: John Yue Jun Jiang, Danville, CA (US)

(72) Inventor: John Yue Jun Jiang, Danville, CA (US)

(73) Assignee: Roamware, Inc., Cupertino, CA (US)

(21) Appl. No.: 13/583,523

(22) PCT Filed: May 2, 2011
(86) PCT No.: PCT/US11/34756

§ 371 Date: Nov. 28, 2012

Related U.S. Application Data
(60) Provisional application No. 61/329,649, filed on Apr. 30, 2010.

(51) Int. Cl. H04W 8/02; H04W 4/14

(52) U.S. Cl. 455/432.1

(57) ABSTRACT

The present invention is directed towards a method for facilitating mobile communication of a subscriber while roaming from HPMN in a VPMN. The method includes intercepting the roamer's MO messages from the VPMN. The method further includes failing delivery of the roamer's MO message. The method further includes delivering the roamer's MO message as an MT message from HPMN.

### RELATED APPLICATIONS

This application claims the benefit of U.S. Provisional Patent Application No. 61/329,649 titled “Seamless SMS Back,” filed on Apr. 30, 2010, the entirety of which is incorporated by this reference herein.

### FIELD OF THE INVENTION

The present invention generally relates to roaming. More specifically, the invention relates to method and system for supporting SMS services while roaming.

### BACKGROUND OF THE INVENTION

Roaming traffic contributes a significant percentage of an operator's revenue and even a better percentage of the operator's margin. With increasing competition and regulatory control, operators are being more pressured to increase their roaming revenue and reduce roaming margin losses. Over the last few years, revenues to the network operators from home subscribers have consistently declined due to increased competition and resulting pricing pressures. On the other hand, revenues from roamers have consistently grown in the same period due to increased mobile penetration in local markets and an increase in travel.

Network operators can maximize their margins if roamers use their mobile services while roaming in visited networks (VPMNs) outside their home network (HPMN). When the subscribers roam into visited networks from an HPMN, they may roam onto multiple VPMNs, one at a time. Generally, these VPMNs charge a wholesale tariff to the HPMN when their subscribers send SMSs while roaming. The HPMN operator then marks up this tariff to produce a retail tariff, ensuring its own margins, and charges the retail tariff to the subscriber. However, when the same subscriber while roaming in VPMN receives an SMS, the VPMN does not charge any tariff towards the HPMN.

Due to this arbitrage difference, various techniques have been devised to try and avoid this wholesale tariff being charged when the roamer sends an SMS from VPMN. In one of the techniques, the roamer sends a USSD request (instead of directly sending an SMS from VPMN) to get a network initiated USSD menu from the HPMN and then the subscriber enters the recipient number followed by the message. However, in this technique, the user experience particularly is not favorable, as the roamer is not able to use his address book, and the user interface is not similar to a normal SMS delivery. Moreover, not all operators may support the USSD services.

In accordance with the foregoing, there is a need in the art of a system, a method, for creating a solution that gives an operator the ways to deal with above mentioned problems and be able to avoid wholesale tariff being applied on MO SMSs from the subscriber, while roaming in VPMN.

### SUMMARY

The present invention is directed towards a method for facilitating mobile communication of a subscriber while roaming from HPMN in a VPMN. The method includes intercepting the roamer's MO messages from the VPMN. The method further includes failing delivery of the roamer's MO message. The method further includes delivering the roamer's MO message as an MT message from HPMN.

The present invention is directed towards a system for directing facilitating mobile communication of a subscriber while roaming from HPMN in a VPMN. The system includes an intercepting module that intercepts the roamer's MO message from the VPMN. The intercepting module further fails the delivery of the MO message. The system further includes a delivery module that delivers the roamer's MO message as an MT message from HPMN.

### BRIEF DESCRIPTION OF DRAWINGS

In the drawings, the same or similar reference numbers identify similar elements or acts.

FIG. 1 illustrates a system for facilitating mobile communication of a subscriber of a Home Public Mobile Network (HPMN) roaming in a Visited Public Mobile Network (VPMN), in accordance with an embodiment of the present invention;

FIG. 2 represents a flowchart for facilitating mobile communication of the subscriber, in accordance with an embodiment of the present invention;

FIG. 3 represents a flow diagram for activating Seamless SMS Back (SSB) Service through SMS, for the subscriber from either the HPMN or the VPMN, in accordance with an embodiment of the present invention;

FIG. 4 represents a flow diagram for activating SSB Service through US SD, for the subscriber from either the HPMN or the VPMN, in accordance with an embodiment of the present invention;

FIG. 5 represents a flow diagram for implementing SSB service without incorporating SSB service module within SMSC, in accordance with an embodiment of the present invention; and

FIG. 6 represents a flow diagram for implementing SSB service in CAP 3 function, in accordance with an embodiment of the present invention.

### DETAILED DESCRIPTION

In the following description, for purposes of explanation, specific numbers, materials and configurations are set forth in order to provide a thorough understanding of the present invention. It will be apparent, however, to one having ordinary skill in the art that the present invention may be practiced without these specific details. In some instances, well-known features may be omitted or simplified, so as not to obscure the present invention. Furthermore, reference in the specification to “one embodiment” or “an embodiment” means that a particular feature, structure or characteristic, described in connection with the embodiment, is included in at least one embodiment of the present invention. The appearance of the phrase “in an embodiment”, in various places in the specification, does not necessarily refer to the same embodiment.

The present invention provides a system, and a method for facilitating mobile communication for a subscriber of a Home Public Mobile Network (HPMN) roaming in a Visited Public Mobile Network (VPMN). In accordance with various embodiments, the present invention provides a method and system for facilitating SMS services of the subscriber while roaming in the VPMN. As the subscriber is roaming in the VPMN, it is hereinafter, interchangeably referred to as roamer.

A roaming partner network corresponds to a network that has at least one roaming agreement such as, but not limited to, Global System for Mobile communication (GSM), General Packet Radio Services (GPRS), Customized Application for Mobile Enhanced Logic (CAMEL) and Third Generation of mobile (3G) agreement with the HPMN. Such a roaming partner network is hereinafter, interchangeably, referred to as preferred VPMN. It will be apparent to a person skilled in the art that roaming services include standard call and non-call related activities such as, but not limited to, Mobile Originated (MO) call, Mobile Terminated (MT) call, Short Message Service (SMS), Packet Data Network (PDN), and other Value Added Services (VASs) such as call forwarding, call barring etc.

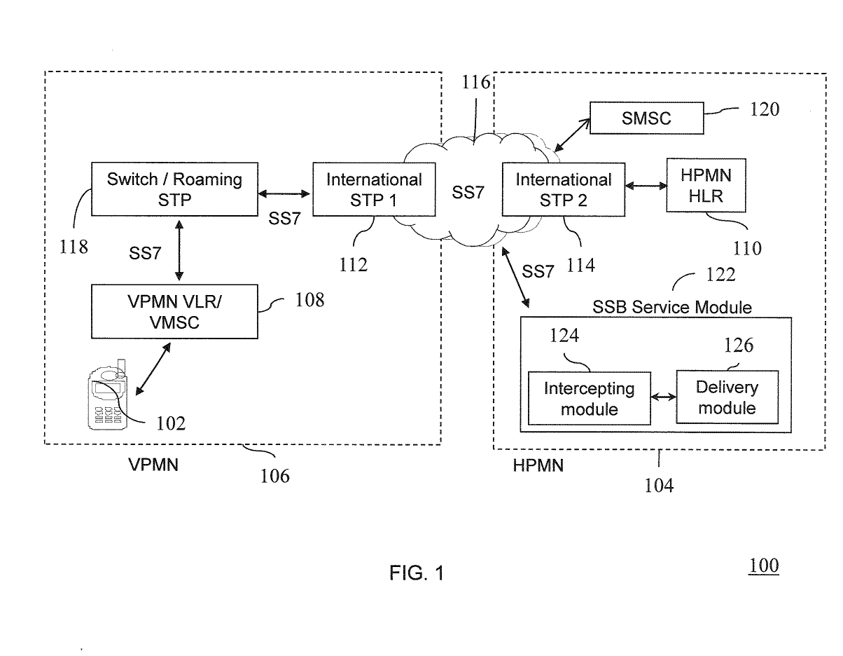

FIG. 1 represents a system 100 for facilitating mobile traffic associated with a subscriber 102 of a Home Public Mobile Network (HPMN) 104, in accordance with an embodiment of the invention. Subscriber 102 using a mobile handset roams outside HPMN 104 at a Visiting Public Mobile Network (VPMN) 106. The subscriber 102 is connected to a VPMN VLR 108, when it is roaming outside HPMN 102. In one embodiment of the invention, VPMN VLR 108 is integrated with a VMSC in VPMN 106. Notwithstanding, both VPMN VLR and VMSC may have different logical addresses. Subscriber profile data corresponding to subscriber 102 is stored in HPMN HLR 110. The signaling corresponding to subscriber 102 is routed using an international STP 1 112 at VPMN 106 and international STP 2 114 at HPMN 104. The signaling between HPMN 104 and VPMN 106 is carried using SS7 signaling architecture 116. The signals exchanged between HPMN 104 and VPMN 106 are MAP based signals. VPMN VLR 108 interacts with international STP 1 112 via a switch 118. In one embodiment of the invention, switch 118 is a roaming STP in VPMN 106.

In another embodiment of the present invention, subscriber 102 sends an SMS while roaming in VPMN 106 through a connection to a Short Message Service Center (SMSC) 120 in HPMN 104.

Other network elements of HPMN 104 (e.g., MSC/VLR) communicate with various other network elements of VPMN 106 (e.g., HLR, VLR etc.) via the SS7 link. It will also be apparent to a person skilled in the art that various components of HPMN 104 communicate with VPMN 106 using various signaling techniques including, but not limited to, SS7, SIP, IP, ISUP etc.

In the existing scenario for sending SMS while roaming in VPMN 106, HPMN 104 is charged a wholesale tariff by VPMN 106. The HPMN 104 then marks up this charge to produce a retail tariff for subscriber 102. In order to stay competitive, and still maintain its margins, HPMN 104 exploits the feature that VPMN 106 does not charge for an MT SMS, but charges for an MO SMS from VPMN 106. Hence, the present invention turns the subscriber's 102 sent MO SMS from VPMN 106, into a received MT SMS, so HPMN 104 can avoid paying wholesale tariff to VPMN 106.

In accordance with various embodiments, the present invention is based on GSM BA27 charging principle where VPMN 106 does not charge HPMN 104 for a failed MO SMS delivery. The present invention, utilizes this principle, whereby system 100 intercepts subscriber's 102 MO SMS (sent from VPMN 106), then fails its delivery so as to avoid wholesale tariff from VPMN 106. The system 100 then delivers the message as an MT SMS from HPMN 104 side by using HPMN SMSC 120. In this case, the SMS is delivered in a seamless manner. Hence, a module that performs this function within system 100 is hereinafter referred as Seamless SMS Back (SSB) module.

In accordance with various embodiments of the present invention, system 100 uses an SSB module 122 to provide the Seamless SMS back service. SSB module 122 further includes an intercepting module 124 and a delivery module 126. The intercepting module 124 intercepts roamer's (i.e., subscriber 102) MO SMS from VPMN 106 and then fails delivery of the roamer's MO message. The delivery module 126 delivers the roamer's MO SMS as an MT SMS from HPMN 104.

It will be apparent to a person skilled in the art that method steps or activities performed by intercepting module 124 and delivery module 126 are distinguished only for the sake of representation. However, since both these sub-modules (i.e., intercepting module 124 and delivery module 126) are part of SSB service module 122, any action step or procedure performed by these two sub-modules is equivalent to it being performed by SSB service module 122 itself, as one unit.

In one embodiment of the invention, SSB service module 122 is deployed by HPMN operator 104. In one embodiment of the invention, SSB service module 122 passively monitors all the signals exchanged between international STP 1 112 in VPMN 106 and international STP 2 114 in HPMN 104, by tracking the SS7 signaling messages. In another embodiment of the present invention, SSB service module 122 actively monitors all signals exchanged between subscriber 102, VPMN 106 and HPMN 104.

It will also be apparent to a person skilled in the art that HPMN 104 and VPMN 106 may also include various other network components (not shown in FIG. 1), depending on the architecture under consideration. In an embodiment of the present invention, various network elements of HPMN 104 and VPMN 106 are located in an IR.21 database (not shown in FIG. 1) such as RAEX IR.21. In an embodiment of the present invention, the IR.21 database is coupled to SSB service module 120.

In accordance with various embodiments of the present invention, the SSB service can be marketed as part of welcome SMS to outbound roamers by HPMN 104. For example, a welcome SMS can be sent to roamer like “Welcome to England, you can send SMS at 50% cheaper via the Roaming Discount SMS service. To opt in for free, dial *121* from your mobile”.

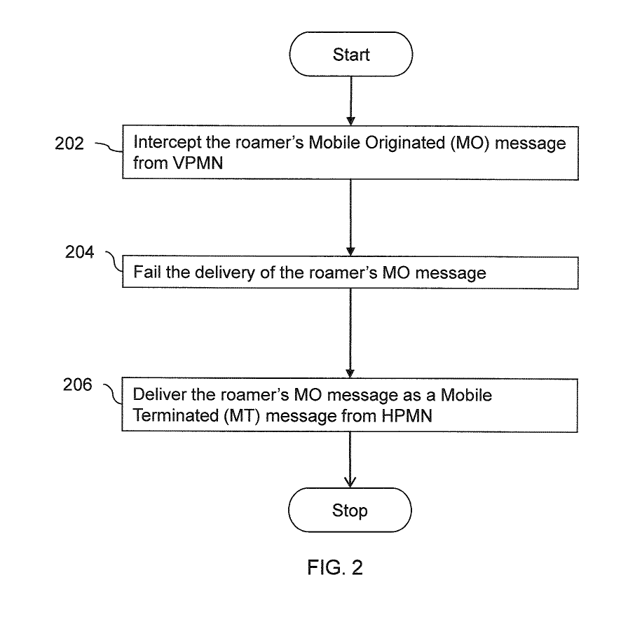

FIG. 2 represents a flowchart for facilitating mobile communication for subscriber 102, in accordance with an embodiment of the present invention. At step 202, intercepting module 124 intercepts roamer's MO SMS sent from VPMN 106. Thereafter, at step 204, intercepting module 124 fails the delivery of the MO SMS to the intended recipient. This failing of delivery ensures that VPMN 106 does not charge HPMN 104 the wholesale tariff. Thereafter, at step 206, delivery module 126 sends the roamer's MO SMS as an MT SMS to the intended recipient. In another embodiment of the present invention, all functions of SSB service module 122 is performed by a messaging module.

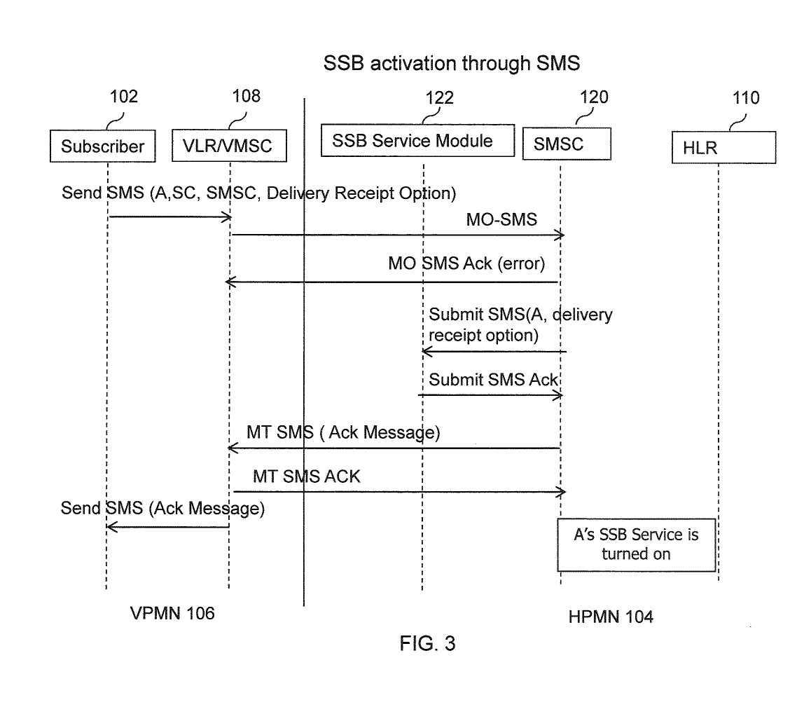

FIG. 3 represents a flow diagram for activating the SSB Service through SMS, for subscriber 102 from either HPMN 104 or VPMN 106, in accordance with an embodiment of the present invention. In order to activate the SSB service, subscriber 102 sends a MO SMS to an activation short-code. The activation response can explain the service to the roamer, e.g “Thanks for opt in to the Roaming Discount SMS service. You can send SMS normally as before. However we will fail your SMS to avoid roaming tariff and subsequently deliver you a message that we have received your message for delivery”. The deactivation of SSB service can follow the same model with a different short-code or service key, or just use the same service key or short-code to toggle the SSB service on or off The activation option may also contain the request of a delivery receipt. In this embodiment, SSB service module 122 detects MO SMS from subscriber 102 by tapping the SS7 signaling messages between HPMN 104 and VPMN 106.

In order to activate SSB service, subscriber 102 sends a MO SMS at a Short-Code (SC) to SMSC 120 with delivery receipt option enabled. This MO SMS is tracked at SMSC of HPMN 104 (if the activation MO SMS is sent while subscriber 102 is roaming in VPMN 106). SMSC 120 then acknowledges the MO SMS with error, back to VMSC 108 of VPMN 106. VPMC further communicates this Send SMS (error) to subscriber 102 handset. Thereafter, SMSC 120 sends a Submit SMS message to SSB service module 122 with delivery receipt option, to enable SSB service for subscriber 102. SSB service module 122 acknowledges the Submit SMS message. Subsequently, SSB service module 122 send an MT SMS as an acknowledgement of the activation request, back to VMSC 108 of VPMN 106. This acknowledgement of the activation request is further sent to subscriber 102 by VMSC 108. In this manner, the SSB service for subscriber 102 is activated while being in VPMN 106. It will be apparent to a person skilled in the art, that a similar call flow will exist even while the subscriber tries to activate the SSB service while being in HPMN 104 itself, just the SMSC will change corresponding to the network (home or visited). Once this SSB service is activated, all subsequent SMSs sent from subscriber 102 at any VPMN are turned into MT SMSs from HPMN.

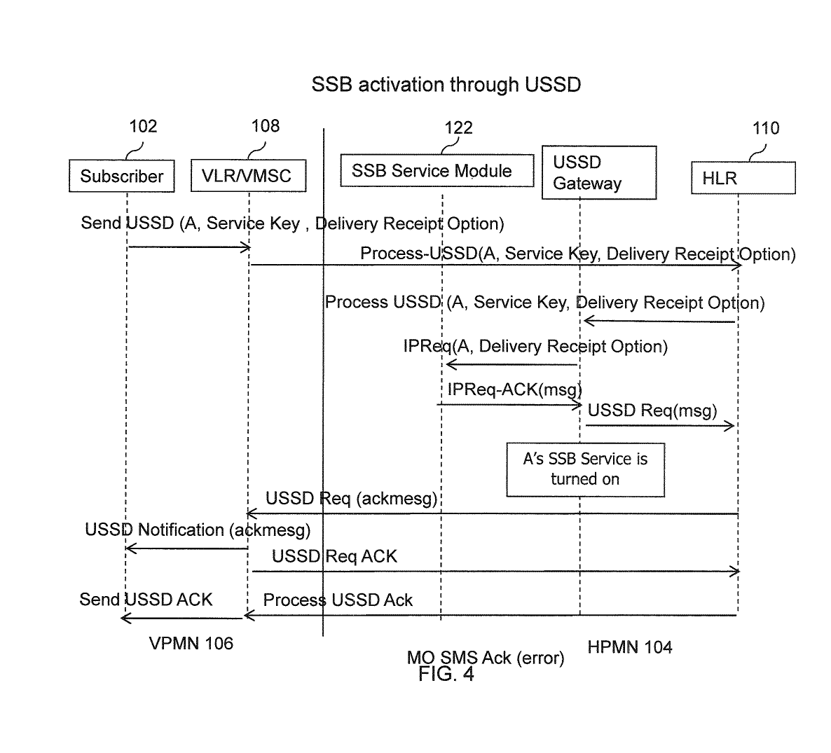

FIG. 4 represents a flow diagram for activating SSB Service through USSD, for subscriber 102 from either HPMN 104 or VPMN 106, in accordance with an embodiment of the present invention. As shown in FIG. 4, subscriber 102 now attempts to activate the SSB service through USSD messaging mechanism. Firstly, subscriber 102 sends a MO SMS (Send USSD) at a Service key with Delivery Receipt option enabled, to VPMC of VPMN 106 (where he is roaming). Thereafter, VPMC sends a Process-USSD message to HPMN HLR 110. Subsequently, HLR 110 sends a USSD message to a USSD Gateway (as shown in FIG. 4) in HPMN 104. The USSD GW then sends a IPReq message from subscriber (A) with Delivery receipt option to SSB service module 122. Thereafter, SSB service module 122 acknowledges the IPReq message back to USSD gateway, which further relays this acknowledgment to HLR 110. Thus, subscriber 102's (A's) SSB service is activated. In order to complete the USSD connection initiated from within VPMN 106, HLR 110 of HPMN 104, sends USSD Request acknowledgment to VPMN VMSC 108, which is further relayed to subscriber 102.

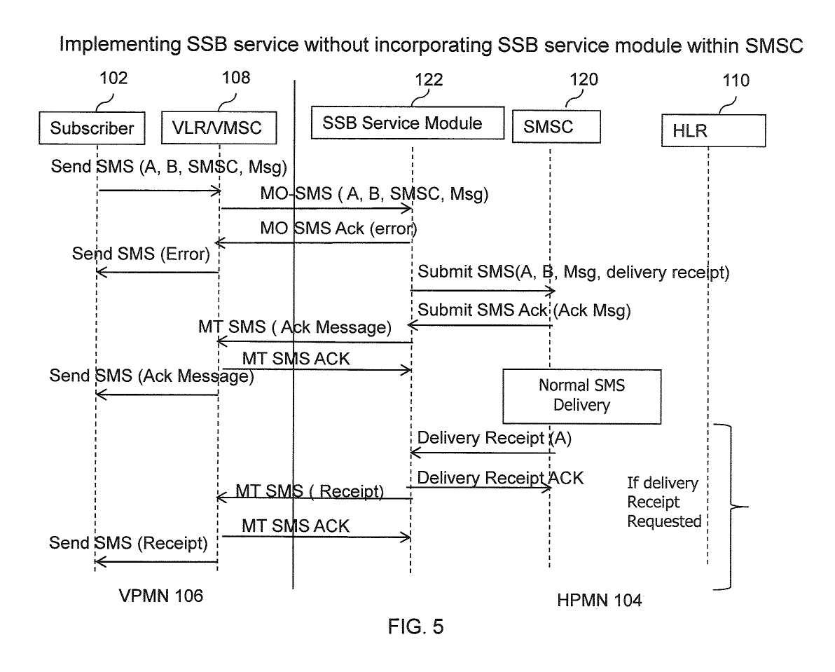

FIG. 5 represents a flow diagram for implementing the SSB service for subscriber 102 without incorporating SSB service module 122 within SMSC 120, in accordance with an embodiment of the present invention. As shown in FIG. 5, subscriber 102 sends an SMS with calling party as A (subscriber 102 itself), called party as B with SMSC 120 to VPMC of VPMN 106. The VMSC 108 further sends this MO-SMS (A, B, SMSC, message) to SSB service module 122. Now since the SSB service of subscriber 102 is activated, SSB service module 122 fails this MO-SMS and sends an acknowledgment with error to VMSC 108 of VPMN 106, which is further relayed to subscriber 102 by VPMN VMSC 108. Thereafter, SSB service module 122 sends the failed MO SMS as Submit SMS (A, B, message, Delivery receipt) to SMSC 120 (of HPMN 104). The SMSC 120 acknowledges the receipt of Submit SMS. Subsequently, SSB service module 122 sends an MT-SMS to VPMN VMSC 108 with acknowledgement, indicating that SSB service module 122 has taken up the initially sent MO-SMS for delivery as an MT-SMS. This acknowledgement is further relayed by VPMN VMSC 108 to subscriber 102. Thereafter, normal SMS delivery follows from SMSC 120's end. Now, if subscriber 102 had initially requested for a Delivery Receipt option in its initially sent MO-SMS, then SMSC 120 sends Delivery Receipt (A) message for subscriber 102 to SSB service module 122. The SSB service module 122 acknowledges the receipt of the message back to SMSC 120 and further sends an MT-SMS (indicating delivery receipt) to VPMN VMSC 108. This delivery receipt acknowledgment MT-SMS is further relayed by VPMN VPMC to subscriber 102, thus completing the call flow.

In summarized form, in this entire call flow, the initially sent MO-SMS from subscriber 102 is first failed for delivery by SSB service module 122, and later SSB service module 122 itself delivers that MO-SMS as an MT SMS to the intended recipient and thereafter sends a delivery receipt to subscriber 102 indicating successful delivery of its MO-SMS.

In another embodiment of the present invention, SMSC 120 is integrated with SSB service module 122. In this case, the entire call flow remains the same, except the messages shown in FIG. 5 to be exchanged between SSB service module 122 and SMSC 120 are not applicable as they are internally implemented within SSB service module 122.

In accordance with various embodiments of the present invention, the roamer experience after activation is different in the following manner. The roamer sends an SMS in a normal manner with menu, user interface and address book. The only difference subscriber sees initially is his handset will indicate a SMS failure. This is in a way good indicating that SSB service module 122 has intercepted the service and failed the message. He just needs to get used to this failing of his SMSs. Since he activated the service earlier, he should be mentally prepared to expect such failed SMSs. Subsequently the SSB service module 122 will send a MT-SMS to inform the roamer that SSB has received the message for delivery. For example, “Airtel Mobile has received your message to 1223443 for delivery”. This is make sure that the failure indication the roamer has received earlier was not due to network issues per se. It will be apparent to a person skilled in the art that this message is optional and free (i.e., no charge from the roaming partner and no charge for the roamer also). Further, if delivery receipt was requested while activation, then SSB service module 122 sends another MT-SMS to the roamer once it got the receipt confirmation from SMSC (internal or external) on the successful delivery. It can be noted again that this is optional and free (i.e., no charge from the roaming partner and no charge for the roamer).

It will be apparent to a person skilled in the art that in order to intercept subscriber 102's SMS, various implementations can be considered. In first embodiment, all roamers' MO-SMS MAP messages are intercepted via MAP screening, by STP's MAP screening function to filter out MO-SMSs from roamers. In second embodiment, SSB service module itself does this screening, if SCCP messages of Called Party (CdParty address is HPMN SMSC and Calling Party (CgPa) is non-HPMN, are routed by STP to SSB service module 122. In third embodiment, in case of CAMEL 3 agreement between HPMN 104 and VPMN 106, SSB service module 122 dynamically inserts a SMS-CSI to the roamer's profile at each location update at VPMN 106, if the roamer has activated the SSB service. Also, SSB service will have a probe function, as in this case only such roamer's SMS will come to SSB service module 122 via CAP. SSB service module 122 aborts the CAP transaction (causing MO-SMS failure at VPMN 106).

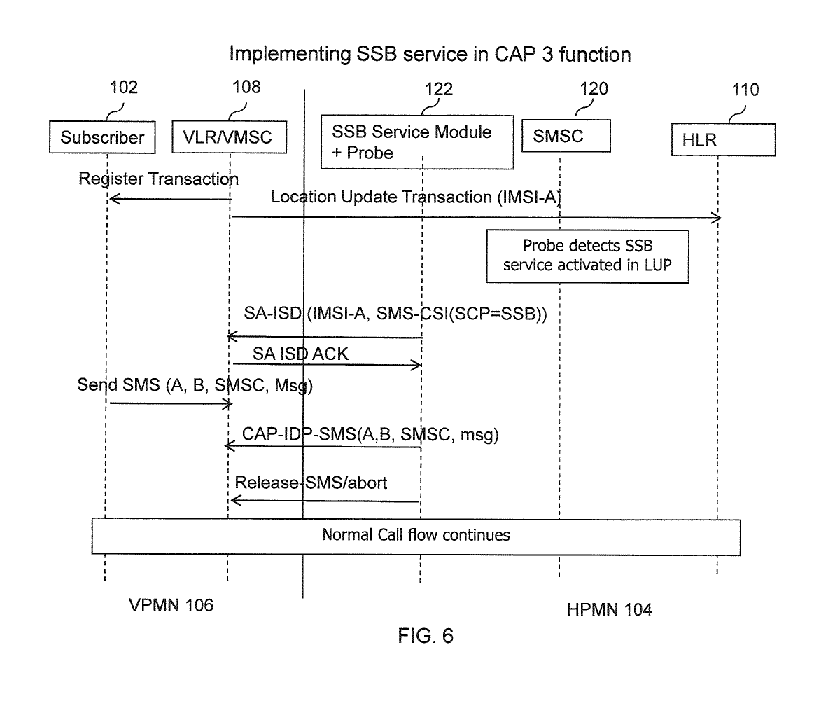

FIG. 6 represents a flow diagram for implementing SSB service in CAP 3 function, in accordance with an embodiment of the present invention. In this embodiment, a probe function is built into the SSB service module 122. This probe detects Location Update (LUP) from subscriber 102, whose SSB service is activated. Thereafter, the probe coupled with SSB service module 122 sends an ISD message with SCP as the SSB service module 122 [SA-ISD (IMSI-A, SMS-CSI(SCP=SSB)] to VPMN 106 to VMSC 108. Thereafter, subscriber 102 sends the SMS to VMSC 108. Subsequently, SSB service module 122 sends a CAP IDP message (A, B, SMSC, message) to VMSC 108 and also releases/aborts the SMS. Once the MO-SMS from subscriber 102 is failed for delivery, then remaining call flow for sending MT SMS from HPMN 104 is similar to as explained in conjunction with above figures.

In accordance with various embodiments of the present invention, SSB service module 122 handles long SMSs sent by subscriber 102's mobile devices. The SMSC 120 is totally transparent to the long SMS, which means SMSC 120 can charge the subscriber 102 for a segment of long SMS even though the rest of segments are rejected. In other embodiment of the present invention, SSB service module 122 wait for all segments of the long SMS to be received, and then SSB service module 122 fails each of those segments. Thereafter, SSB service module 122 sends the recipient a delivery SMS. Subsequently, SSB service module 122 then passes each segment to SMSC 120 for delivery. It may be possible that one segment is charged where others are rejected (e.g. as subscriber is out of balance).

In another embodiment of the present invention, SSB service module 122 might be restricted or allowed by certain operators. This is controlled by maintain white list and blacklist.

In accordance with various embodiments of the present invention, subscriber 102 is charged in postpaid and prepaid scenarios. In case the subscriber 102 is a postpaid subscriber, then in case SMSC 120 is external to SSB service module 122, then SMSC 120 charges normally as before and produces CDR that indicates VMSC's address. However, in this case, VMSC is the SSB address which warrants a special billing per operator. In case the SMSC 120 is internally built within SSB service module 122, then SSB service module 122 generates the CDR with SSB address as VMSC address and feeds that CDR to the billing system.

In some embodiments of the present invention, SMSCs does not have location based billing but they rely on prefixes to handle the special billing. In this case, for internal SMSC, SSB service module 122 generates the CDR with a special marker on called number, i.e., B-party, e.g. prefix for the billing system to bill. In case the SMSC is external, SSB service module 122 prefixes the B-party number before submitting to SMSC 120. Thereafter, SMSC 120 uses the prefix to generate proper billing and removes the prefix before delivery.

In accordance with another embodiment of the present invention, subscriber 102 is a prepaid subscriber. Now in case the SMSC is external to SSB service module 122, SMSC 120 interfaces with PrePaid System (PPS) normally as before (e.g. through hot billing). Thereafter, SMSC 120 produces hot billing interface CDR that indicates the VMSC address. In this case VMSC address is the SSB service module's address which warrants a special billing per operator decision by the hot billing system. However, in case the SMSC is integrated with SSB service module 122, then SSB service module 122 needs to interface with PPS directly (via IP or CAP 3) with SSB address as the VMSC address.

In some cases SMSCs do not have location based billing but rely on prefixes to do special billing. Now in case the SMSC is integrated, SSB service module 122 interfaces with the PPS directly (via IP or CAP 3) with a special marker on B-party, e.g. prefix for the billing system to bill. In case SMSC is external, SSB service module 122 prefixes the B-party number before submitting to SMSC. Thereafter, the SMSC uses this prefix to interface with the PPS and remove the prefix before delivery.

It will be apparent to a person skilled in the art, that the present invention can also be applied to Code Division Multiple Access (CDMA)/American National Standards Institute #41D (ANSI-41D), and various other technologies such as, but not limited to, VoIP, WiFi, 3GSM and inter-standard roaming. In one exemplary case, a CDMA outbound roamer travels with an HPMN CDMA handset. In another exemplary case, the CDMA outbound roamer travels with an HPMN GSM SIM and a GSM handset. In yet another exemplary case, GSM outbound roamer travels with an HPMN CDMA RUIM and a CDMA handset. To support these variations, system 100 will have a separate SS7 and network interfaces, corresponding to both the HPMN and VPMN networks. It will also be apparent to a person skilled in the art that these two interfaces in different directions may not have to be the same technologies. Moreover, there could be multiple types of interface in both directions.

An exemplary list of the mapping between GSM MAP and ANSI-41D is described in the table below as a reference.

| GSM MAP | ANSI-41D |
|---|---|
| Location Update/ISD | REGNOT |
| Cancel Location | REGCAN |
| RegisterSS | FEATUREREQUEST |
| InterrogateSS | FEATUREREQUEST |
| SRI-SM | SMSREQ |
| SRI | LOCATION REQUEST |
| ForwardSMS | SMSDPP |
| ReadyForSMS | SMSNOTIFICATION |
| AlertServiceCenter | SMSNOTIFICATION |
| ReportSMSDelivery | SMDPP |
| ProvideRoamingNumber | ROUTING REQUEST |

The present invention can take the form of an entirely hardware embodiment, an entirely software embodiment, or an embodiment containing both hardware and software elements. In accordance with an embodiment of the present invention, software, including but not limited to, firmware, resident software, and microcode, implements the invention.

Furthermore, the invention can take the form of a computer program product, accessible from a computer-usable or computer-readable medium providing program code for use by, or in connection with, a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CDROM), compact disk-read/write (CD-R/W) and Digital Versatile Disk (DVD).

The components of present system described above include any combination of computing components and devices operating together. The components of the present system can also be components or subsystems within a larger computer system or network. The present system components can also be coupled with any number of other components (not shown), such as other buses, controllers, memory devices, and data input/output devices, in any number of combinations. In addition, any number or combination of other processor-based components may be carrying out the functions of the present system.

It should be noted that the various components disclosed herein may be described using computer aided design tools and/or expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but may not be limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, it covers all of the following interpretations: any of the items in the list, all of the items in the list and any combination of the items in the list.

The above description of illustrated embodiments of the present system is not intended to be exhaustive or to limit the present system to the precise form disclosed. While specific embodiments of, and examples for, the present system are described herein for illustrative purposes, various equivalent modifications are possible within the scope of the present system, as those skilled in the art will recognize. The teachings of the present system provided herein can be applied to other processing systems and methods. They may not be limited to the systems and methods described above.

The elements and acts of the various embodiments described above can be combined to provide further embodiments. These and other changes can be made in light of the above detailed description.

### Other Variations

Provided above for the edification of those of ordinary skill in the art, and not as a limitation on the scope of the invention, are detailed illustrations of a scheme for proactive roaming tests, discoveries of roaming partner services and discoveries of frauds in roaming using simulated roaming traffic. Numerous variations and modifications within the spirit of the present invention will of course occur to those of ordinary skill in the art in view of the embodiments that have been disclosed. For example, the present invention is implemented primarily from the point of view of GSM mobile networks as described in the embodiments. However, the present invention may also be effectively implemented on GPRS, 3G, CDMA, WCDMA, WiMax etc., or any other network of common carrier telecommunications in which end users are normally configured to operate within a “home” network to which they normally subscribe, but have the capability of also operating on other neighboring networks, which may even be across international borders.

The examples under the system of present invention detailed in the illustrative examples contained herein are described using terms and constructs drawn largely from GSM mobile telephony infrastructure. However, use of these examples should not be interpreted as limiting the invention to those media. The system and method can be of use and provided through any type of telecommunications medium, including without limitation: (i) any mobile telephony network including without limitation GSM, 3GSM, 3G, CDMA, WCDMA or GPRS, satellite phones or other mobile telephone networks or systems; (ii) any so-called WiFi apparatus normally used in a home or subscribed network, but also configured for use on a visited or non-home or non-accustomed network, including apparatus not dedicated to telecommunications such as personal computers, Palm-type or Windows Mobile devices; (iii) an entertainment console platform such as Sony Playstation, PSP or other apparatus that are capable of sending and receiving telecommunications over home or non-home networks, or even (iv) fixed-line devices made for receiving communications, but capable of deployment in numerous locations while preserving a persistent subscriber id such as the eye2eye devices from Dlink; or telecommunications equipment meant for voice over IP communications such as those provided by Vonage or Packet8.

In describing certain embodiments of the system under the present invention, this specification follows the path of a telecommunications call, from a calling party to a called party. For the avoidance of doubt, such a call can be a normal voice call, in which the subscriber telecommunications equipment is also capable of visual, audiovisual or motion-picture display. Alternatively, those devices or calls can be for text, video, pictures or other communicated data.

In the foregoing specification, specific embodiments of the present invention have been described. However, one of ordinary skill in the art will appreciate that various modifications and changes can be made without departing from the scope of the present invention as set forth in the claims below. Accordingly, the specification and the figures are to be regarded in an illustrative rather than a restrictive sense, and all such modifications are intended to be included within the scope of present invention. The benefits, advantages, solutions to problems, and any element(s) that may cause any benefit, advantage, or solution to occur, or to become more pronounced, are not to be construed as a critical, required, or essential feature or element of any or all of the claims.

APPENDIX

| Acronym | Description |
|---|---|
| 3G | Third generation of mobile |
| ACM | ISUP Address Completion Message |
| ANM | ISUP Answer Message |
| ANSI-41 | American National Standards Institute #41 |
| ATI | Any Time Interrogation |
| BCSM | Basic Call State Model |
| BSC | Base Station Controller |
| BOIC | Barring Outgoing International Calls |
| BOIC-EX- | Barring Outgoing International Calls except to home |
| Home | country |
| CAMEL | Customized Application for Mobile Enhanced Logic |
| CAP | Camel Application Part |
| CB | Call Barring |
| CC | Country Code |
| CDMA | Code Division Multiplexed Access |
| CdPA | Called Party Address |
| CDR | Call Detail Record |
| CF | Call Forwarding |
| CgPA | Calling Party Address |
| CIC | Circuit Identification Code |
| CLI | Calling Line Identification |
| CSD | Circuit Switched Data |
| CSI | Camel Subscription Information |
| DPC | Destination Point Code |
| DSD | Delete Subscriber Data |
| DTMF | Dual Tone Multi-Frequency |
| ERB | CAP Event Report Basic call state model |
| EU | European Union |
| FPMN | Friendly Public Mobile Network |
| FTN | Forward-To-Number |
| GLR | Gateway Location Register |
| GGSN | Gateway GPRS Support Node |
| GMSC | Gateway MSC |
| GMSC-F | GMSC in FPMN |
| GMSC-H | GMSC in HPMN |
| GPRS | General Packet Radio System |
| GSM | Global System for Mobile |
| GSMA | GSM Association |
| GSM SSF | GSM Service Switching Function |
| GsmSCF | GSM Service Control Function |
| GT | Global Title |
| GTP | GPRS Tunnel Protocol |
| HLR | Home Location Register |
| HPMN | Home Public Mobile Network |
| IN | Intelligent Network |
| IOT | Inter-Operator Tariff |
| GTT | Global Title Translation |
| IAM | Initial Address Message |
| IDP | Initial DP IN/CAP message |
| IDD | International Direct Dial |
| IMSI | International Mobile Subscriber Identity |
| IMSI-H | HPMN IMSI |
| IN | Intelligent Network |
| INAP | Intelligent Network Application Part |
| INE | Interrogating Network Entity |
| IP | Internet Protocol |
| IREG | International Roaming Expert Group |
| IRS | International Revenue Share |
| ISC | International Service Carrier |
| ISD | MAP Insert Subscriber Data |
| ISG | International Signal Gateway |
| IST | Immediate Service Termination |
| ISTP | International STP |
| ISTP-F | ISTP connected to FPMN STP |
| ISTP-H | ISTP connected to HPMN STP |
| ISUP | ISDN User Part |
| ITPT | Inbound Test Profile Initiation |
| ITR | Inbound Traffic Redirection |
| IVR | Interactive Voice Response |
| LU | Location Update |
| LUP | MAP Location Update |
| MAP | Mobile Application Part |
| MCC | Mobile Country Code |
| MCC | Mobile Country Code |
| MD | Missing Data |
| ME | Mobile Equipment |
| MGT | Mobile Global Title |
| MMS | Multimedia Message Service |
| MMSC | Multimedia Message Service Center |
| MMSC-F | FPMN MMSC |
| MMSC-H | HPMN MMSC |
| MNC | Mobile Network Code |
| MNP | Mobile Number Portability |
| MO | Mobile Originated |
| MOS | Mean Opinion Score |
| MS | Mobile Station |
| MSC | Mobile Switching Center |
| MSISDN | Mobile Station International Subscriber Directory Number |
| MSISDN-F | FPMN MSISDN |
| MSISDN-H | HPMN MSISDN |
| MSRN | Mobile Station Roaming Number |
| MSRN-F | FPMN MSRN |
| MSRN-H | HPMN MSRN |
| MT | Mobile Terminated |
| MTP | Message Transfer Part |
| NDC | National Dialing Code |
| NP | Numbering Plan |
| NPI | Numbering Plan Indicator |
| NRTRDE | Near Real Time Roaming Data Exchange |
| O-CSI | Originating CAMEL Subscription Information |
| OCN | Original Called Number |
| ODB | Operator Determined Barring |
| OPC | Origination Point Code |
| OR | Optimal Routing |
| ORLCF | Optimal Routing for Late Call Forwarding |
| OTA | Over The Air |
| OTPI | Outbound Test Profile Initiation |
| PDP | Protocol Data Packet |
| PDN | Packet Data Network |
| PDU | Packet Data Unit |
| PRN | MAP Provide Roaming Number |
| PSI | MAP Provide Subscriber Information |
| QoS | Quality of Service |
| RAEX | Roaming Agreement EXchange |
| RI | Routing Indicator |
| RIS | Roaming Intelligence System |
| RDN | Redirecting Number |
| RNA | Roaming Not Allowed |
| RR | Roaming Restricted due to unsupported feature |
| RRB | CAP Request Report Basic call state model |
| RSD | Restore Data |
| RTP | Real-Time Transport Protocol |
| SAI | Send Authentication Info |
| SC | Short Code |
| SCA | Smart Call Assistant |
| SCCP | Signal Connection Control part |
| SCP | Signaling Control Point |
| SF | System Failure |
| SG | Signaling Gateway |
| SGSN | Serving GPRS Support Node |
| SGSN-F | FPMN SGSN |
| SIM | Subscriber Identity Module |
| SIGTRAN | Signaling Transport Protocol |
| SME | Short Message Entity |
| SM-RP-UI | Short Message Relay Protocol User Information |
| SMS | Short Message Service |
| SMSC | Short Message Service Center |
| SMSC-F | FPMN SMSC |
| SMSC-H | HPMN SMSC |
| SoR | Steering of Roaming |
| SPC | Signal Point Code |
| SRI | MAP Send Routing Information |
| SRI-SM | MAP Send Routing Information For Short Message |
| SS | Supplementary Services |
| SS7 | Signaling System #7 |
| SSN | Sub System Number |
| SSP | Service Switch Point |
| STK | SIM Tool Kit Application |
| STP | Signal Transfer Point |
| STP-F | FPMN STP |
| STP-H | HPMN STP |
| TADIG | Transferred Account Data Interchange Group |
| TAP | Transferred Account Procedure |
| TCAP | Transaction Capabilities Application Part |
| VT-CSI | Visited Terminating CAMEL Service Information |
| TP | SMS Transport Protocol |
| TR | Traffic Redirection |
| TS | Traffic Steering |
| TT | Translation Type |
| UD | User Data |
| UDH | User Data Header |
| UDHI | User Data Header Indicator |
| USSD | Unstructured Supplementary Service Data |
| VAS | Value Added Service |
| VIP | Very Important Person |
| VLR | Visited Location Register |
| VLR-F | FPMN VLR |
| VLR-H | HPMN VLR |
| VLR-V | VPMN VLR |
| VMSC | Visited Mobile Switching Center |
| VoIP | Voice over IP |
| VPMN | Visited Public Mobile Network |
| ATI | Access Transport Information |
| UDV | Unexpected Data Value |
| USI | User Service Information |
| WAP | Wireless Access Protocol |

### TECHNICAL REFERENCES, EACH OF WHICH IS INCORPORATED BY REFERENCE HEREIN IN ITS ENTIRETY

John Jiang [PI 2007] A single operator and network side solution for inbound and Outbound roaming tests and discoveries of roaming partner services and frauds without involving remote probes or real roamer traffic—Phase 1
John Jiang and David Gillot [PI 2008] A single operator and network side solution for inbound and outbound roaming tests and discoveries of roaming partner services and frauds without involving remote probes or real roamer traffic
GSM 378 on CAMEL Digital Cellular telecommunications system (Phase 2+); Customized Applications for Mobile network Enhanced Logic (CAMEL) Phase 2; Stage 2 (GSM 03.78 version 6.7.0 Release 1997)
GSM 978 on CAMEL Application protocol Digital cellular telecommunications system (Phase 2+); Customized Applications for Mobile network Enhanced Logic (CAMEL); CAMEL Application Part (CAP) specification (GSM 09.78 version 7.1.0 Release 1998)
GSM 379 on CAMEL Digital cellular telecommunications system (Phase 2+); Customized Applications for Mobile network Enhanced Logic (CAMEL); CAMEL Application Part (CAP) specification (GSM 09.78 version 7.1.0 Release 1998)
GSM 318 on CAMEL Basic Call Handling; Digital cellular telecommunications system (Phase 2+) Basic call handling; Technical realization (GSM 03.18 version 6.6.0 Release 1997)
IREG 32
IREG 24
ITU-T Recommendation Q.1214 (1995), Distributed functional plane for intelligent network CS-1;
ITU-T Recommendation Q.1218 (1995), Interface Recommendation for intelligent network CS-1;
ITU-T Recommendation Q.762 (1999), Signaling system No. 7—ISDN user part general functions of messages and signals;
ITU-T Recommendation Q.763 (1999), Signaling system No. 7—ISDN user part formats and codes;
ITU-T Recommendation Q.764 (1999), Signaling system No. 7—ISDN user part signaling procedures;
ITU-T Recommendation Q.766 (1993), Performance objectives in the integrated services digital network application;
ITU-T Recommendation Q.765 (1998), Signaling system No. 7—Application transport mechanism;
ITU-T Recommendation Q.769.1 (1999), Signaling system No. 7—ISDN user part enhancements for the support of Number Portability
BA 19 GSMA RAEX on AA 14 and IR 21
FF 17 International Revenue Share Fraud

I claim:

1. A method for facilitating mobile communications of a roamer associated with a Home Public Mobile Network (HPMN) roaming in a Visited Public Mobile Network (VPMN), the method comprising:
intercepting a Mobile Originated (MO) message of the roamer from the VPMN;
failing delivery of the MO message; and
delivering the MO message as a Mobile Terminated (MT) message from the HPMN.

2. The method of claim 1, wherein the MO message is intercepted by a messaging module.

3. The method of claim 2, wherein the messaging module is a Seamless Short Message Service (SMS) Back (SSB) service module.

4. The method of claim 1, wherein the MO message is intercepted by screening a Signal Transfer Point (STP) Mobile Application Part (MAP) messages.

5. The method of claim 1, wherein the MT message is delivered from the HPMN by using one of a HPMN Short Message Service Center (SMSC) and an integrated SMSC with SSB service module.

6. The method of claim 1, wherein the roamer activates SSB service through one of a Unstructured Supplementary Service Data (USSD) request on a service key and a MO message to a short code.

7. The method of claim 1, wherein the delivery failure of the MO message is indicated to the roamer by a SSB service module.

8. The method of claim 1, wherein the delivery failure of the MO message is indicated to the roamer by sending a MT message to the roamer by a SSB service module.

9. The method of claim 1, further comprising sending a delivery receipt of the MO message, by sending a MT message to the roamer by a SSB service module.

10. The method of claim 1, wherein the MO message from the roamer is a long message and is intercepted in one or more segments.

11. The method of claim 10, wherein each of the one or more segments is failed for delivery.

12. The method of claim 10, wherein each of the one or more segments is sent to a SMSC for delivery.

13. The method of claim 1, wherein the roamer is billed using one of a postpaid or a prepaid billing mechanism.

14. A system for facilitating mobile communications of a roamer associated with a Home Public Mobile Network (HPMN) roaming in a Visited Public Mobile Network (VPMN), the system comprising:
a messaging module that intercepts a Mobile Originated (MO) message of the roamer from the VPMN; and
a fail delivery module that fails delivery of the MO message;
wherein the messaging module delivers the MO message as a Mobile Terminated (MT) message from the HPMN.

15. The system of claim 14, wherein the messaging module is a Seamless Short Message Service (SMS) Back (SSB) service module.

16. The system of claim 14, wherein a Short Message Service Center (SMSC) integrated with the messaging module delivers the MT message from the HPMN.

17. The system of claim 14, wherein the messaging module sends a delivery failure notification of the MO message to the roamer.

18. The system of claim 14, wherein the MO message from the roamer is a long message and is intercepted by the messaging module in one or more segments.

19. A system for facilitating mobile communications of a roamer associated with a Home Public Mobile Network (HPMN) roaming in a Visited Public Mobile Network (VPMN), the system comprising:
an interception module that intercepts a Mobile Originated (MO) message of the roamer from the VPMN, wherein the interception module fails delivery of the MO message; and
a delivery module that delivers the MO message as a Mobile Terminated (MT) message from HPMN.

20. The system of claim 19, wherein the interception module and the delivery module are coupled to form a Seamless Short Message Service (SMS) Back (SSB) service module.
